(19) United States
(12) Patent Application Publication
(10) Pub. No.: US 2026/0134832 A1
(43) Pub. Date: May 14, 2026

(54) PIXEL AND ELECTRONIC DEVICE

(71) Applicants: Samsung Display Co., Ltd., Yongin-Si (KR); Konkuk University Industrial Cooperation Corp., Seoul (KR)

(72) Inventors: HYUNJOON KIM, Yongin-si (KR); YIKYOUNG YOU, Seoul (KR); KEECHAN PARK, Seoul (KR); DANWON LIM, Yongin-si (KR); JAEHYUNG CHO, Yongin-si (KR)

(21) Appl. No.: 19/331,293

(22) Filed: Sep. 17, 2025

(30) Foreign Application Priority Data
Nov. 11, 2024 (KR) 10-2024-0158991

(51) Int. Cl. G09G 3/3233

(52) U.S. Cl. CPC G09G 3/3233; G09G 2300/0852; G09G 2300/0861; G09G 2310/08; G09G 2320/0233; G09G 2320/0257; G09G 2330/021; G09G 2340/0435

(57) ABSTRACT

Disclosed is a pixel including a light emitting element connected between a first power source line, through which a first power source is provided, and a first node, a first transistor including a first electrode, a second electrode connected to a second power source line provided with a second power source having a lower voltage level than the first power source, a first gate electrode connected to a second node, and a second gate electrode provided with a gate voltage, a first capacitor, a second transistor connected to a data line and including a gate electrode for receiving a first scan signal, and a second capacitor. A voltage obtained by subtracting a voltage of the second electrode from a voltage of the second gate electrode has a negative voltage level.

### CROSS-REFERENCE TO RELATED APPLICATIONS

This application claims priority under 35 U.S.C. § 119 to Korean Patent Application No. 10-2024-0158991 filed on Nov. 11, 2024, in the Korean Intellectual Property Office, the disclosures of which are incorporated by reference herein in their entireties.

### BACKGROUND

Embodiments of the present disclosure described herein relate to a pixel and an electronic device with improved reliability.

An electronic device may be a device composed of various electronic parts such as a display panel displaying an image, an input sensor sensing an external input, and an electronic module. The electronic parts may be electrically connected to each other by signal lines thus variously arranged. The display panel includes a plurality of pixels. Each of the plurality of pixels includes a light emitting element that generates light, and a pixel driving circuit that controls the amount of current flowing through the light emitting element. When a leakage current occurs in the pixel driving circuit within a pixel, a change occurs in the amount of current flowing through the light emitting element, thereby degrading display quality.

### SUMMARY

Embodiments of the present disclosure provide a pixel and an electronic device with improved reliability.

According to an embodiment, a pixel includes a light emitting element connected between a first power source line, through which a first power source is provided, and a first node, a first transistor including a first electrode connected to the first node, a second electrode connected to a second power source line provided with a second power source having a lower voltage level than the first power source, a first gate electrode connected to a second node, and a second gate electrode provided with a gate voltage, a first capacitor connected between the second node and a third node, a second transistor connected between a data line, to which a data signal is provided, and the third node and including a gate electrode for receiving a first scan signal, and a second capacitor connected between the second node and the second power source line. A voltage obtained by subtracting a voltage of the second electrode from a voltage of the second gate electrode has a negative voltage level.

A semiconductor layer of each of the first transistor and the second transistor may include an oxide semiconductor.

The pixel may further include a fourth transistor connected between the first node and the first power source line and including a gate electrode receiving a second scan signal.

The pixel may further include a sixth transistor connected between the third node and a ground electrode and including a gate electrode receiving the second scan signal.

The pixel may further include a third transistor connected between the second node and the first transistor and including a gate electrode.

A third scan signal may be provided to the gate electrode of the third transistor.

The second scan signal may be provided to the gate electrode of the third transistor.

The pixel may further include a fifth transistor connected between the first node and the first transistor and including a gate electrode receiving an emission signal.

The pixel may further include a seventh transistor connected between the first node and the second node and including a gate electrode receiving a scan signal obtained by shifting the first scan signal by a predetermined time.

During a first period, the scan signal and the second scan signal may be at active levels.

During the first period, the first power source may be provided to the first node and the second node.

During a second period continuous with the first period, the second scan signal and the third scan signal may be at active levels.

During the second period, a voltage value obtained by adding a threshold voltage of the first transistor to the second power source may be provided to the second node.

During a third period continuous with the second period, the first scan signal may be at an active level.

During the third period, the data signal may be provided to the third node, and a length of the third period may be smaller than a length of the second period.

During a fourth period continuous with the third period, the emission signal may be at an active level.

According to an embodiment, an electronic device includes a display panel including a plurality of pixels. Each of the plurality of pixels includes a light emitting element connected between a first power source line, through which a first power source is provided, and a first node, a first transistor connected between the first node and a second power source line provided with a second power source having a lower voltage level than the first power source and including a first gate electrode connected to a second node and a second gate electrode provided with a gate voltage, a first capacitor connected between the second node and a third node, a second transistor connected between a data line, to which a data signal is provided, and the third node and including a gate electrode for receiving a first scan signal, a second capacitor connected between the second node and the second power source line, a fourth transistor connected between the first node and the first power source line and including a gate electrode receiving a second scan signal, and a third transistor connected between the second node and the first transistor and including a gate electrode receiving a third scan signal. A voltage obtained by subtracting the second power source from the gate voltage has a negative voltage level.

A semiconductor layer of each of the first transistor and the second transistor may include an oxide semiconductor.

During a second period, the second scan signal and the third scan signal may be at active levels, and a voltage value obtained by adding a threshold voltage of the first transistor to the second power source may be provided to the second node.

During a third period continuous with the second period, the first scan signal may be at an active level, the data signal may be provided to the third node, and a length of the third period may be smaller than a length of the second period.

### BRIEF DESCRIPTION OF THE FIGURES

The above and other features of the present disclosure will become apparent by describing in detail embodiments thereof with reference to the accompanying drawings.

FIG. 1 is a block diagram of an electronic device, according to embodiments of the present disclosure.

FIG. 2 is a perspective view of an electronic device, according to an embodiment of the present disclosure.

FIG. 3 is a block diagram of an electronic device, according to an embodiment of the present disclosure.

FIG. 4 is an equivalent circuit diagram of a pixel, according to an embodiment of the present disclosure.

FIG. 5 is a timing diagram for describing an operation of an electronic device, according to an embodiment of the present disclosure.

FIG. 6 is a diagram for describing an operation of a pixel, according to an embodiment of the present disclosure.

FIG. 7 is a diagram for describing an operation of a pixel, according to an embodiment of the present disclosure.

FIGS. 8A, 8B, and 8C are graphs illustrating characteristics of a transistor, according to an embodiment of the present disclosure.

FIG. 9 is a diagram for describing an operation of a pixel, according to an embodiment of the present disclosure.

FIG. 10 is a diagram for describing an operation of a pixel, according to an embodiment of the present disclosure.

FIG. 11 is an equivalent circuit diagram of a pixel, according to an embodiment of the present disclosure.

FIG. 12 is a timing diagram for describing an operation of an electronic device, according to an embodiment of the present disclosure.

### DETAILED DESCRIPTION

In the specification, the expression that a first component (or region, layer, part, portion, etc.) is “on”, “connected with”, or “coupled with” a second component means that the first component is directly on, connected with, or coupled with the second component or means that a third component is interposed therebetween.

The same reference numerals refer to the same components. Also, in drawings, the thickness, ratio, and dimension of components are exaggerated for effectiveness of description of technical contents. The term “and/or” includes one or more combinations in each of which associated elements are defined.

Although the terms “first”, “second”, etc. may be used to describe various components, the components should not be construed as being limited by the terms. The terms are only used to distinguish one component from another component. For example, without departing from the scope and spirit of the present disclosure, a first component may be referred to as a second component, and similarly, the second component may be referred to as the first component. The articles “a,” “an,” and “the” are singular in that they have a single referent, but the use of the singular form in the specification should not preclude the presence of more than one referent.

Also, the terms “under”, “below”, “on”, “above”, etc. are used to describe the correlation of components illustrated in drawings. The terms that are relative in concept are described based on a direction shown in drawings.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, or components or a combination thereof.

Terms “part” and “unit” mean a software component or a hardware component that performs a specific function. For example, the hardware component may include a field-programmable gate array (FPGA) or an application-specific integrated circuit (ASIC). The software component may refer to executable codes and/or data used by the executable codes in an addressable storage medium. Accordingly, the software components may be, for example, object-oriented software components, class components, and task components, and may include processes, functions, attributes, procedures, subroutines, program code segments, drivers, firmware, microcodes, circuits, data, databases, data structures, tables, arrays, or variables.

Unless otherwise defined, all terms (including technical terms and scientific terms) used in the specification have the same meaning as commonly understood by one skilled in the art to which the present disclosure belongs. Furthermore, terms such as terms defined in the dictionaries commonly used should be interpreted as having a meaning consistent with the meaning in the context of the related technology, and should not be interpreted in ideal or overly formal meanings unless explicitly defined herein.

Hereinafter, embodiments of the present disclosure will be described with reference to accompanying drawings.

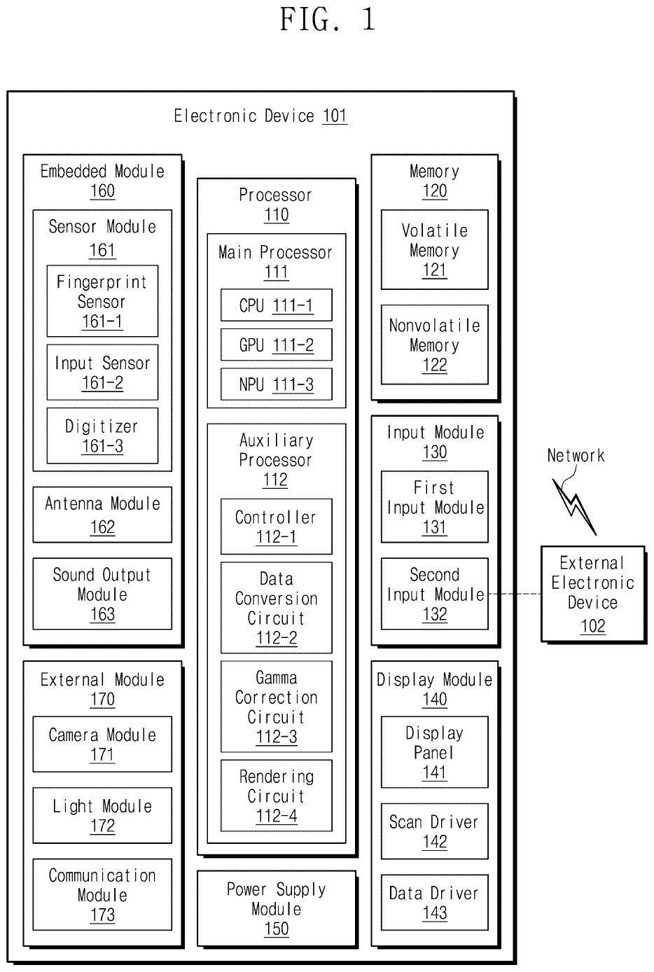

FIG. 1 is a block diagram of an electronic device 101, according to embodiments of the present disclosure.

Referring to FIG. 1, the electronic device 101 outputs various pieces of information through a display module 140 within an operating system. When a processor 110 executes an application stored in a memory 120, the display module 140 provides application information to a user through a display panel 141.

The processor 110 obtains an external input through an input module 130 or a sensor module 161 and executes an application corresponding to the external input. For example, when the user selects a camera icon displayed on the display panel 141, the processor 110 obtains a user input through an input sensor 161-2 and activates a camera module 171. The processor 110 delivers image data corresponding to a captured image obtained through the camera module 171 to the display module 140. The display module 140 may display an image corresponding to the captured image through the display panel 141.

For another example, when personal information is authenticated on the display module 140, a fingerprint sensor 161-1 obtains entered fingerprint information as input data. The processor 110 compares input data obtained through the fingerprint sensor 161-1 with authentication data stored in the memory 120 and executes an application based on the comparison result. The display module 140 may display information, which is executed depending on the logic of the application, through the display panel 141.

For another example, when a music streaming icon displayed on the display module 140 is selected, the processor 110 obtains a user input through the input sensor 161-2 and activates the music streaming application stored in the memory 120. When a music play command is input by the music streaming application, the processor 110 provides sound information corresponding to the music play command to the user by activating a sound output module 163.

The operation of the electronic device 101 has been briefly described above. Hereinafter, a configuration of the electronic device 101 will be described in detail. Some of components of the electronic device 101, which will be described below, may be integrated and provided as one configuration, or the one configuration may be provided to be separated into two or more configurations.

The electronic device 101 may communicate with an external electronic device 102 through a network (e.g., a short-range wireless communication network or a long-range wireless communication network). According to an embodiment, the electronic device 101 may include the processor 110, the memory 120, the input module 130, the display module 140, a power supply module 150, an embedded module 160, and an external module 170. According to an embodiment, in the electronic device 101, at least one of the above-described components may be omitted, or one or more other components may be added. According to an embodiment, some (e.g., the sensor module 161, an antenna module 162, or the sound output module 163) of the components described above may be integrated into another component (e.g., the display module 140).

The processor 110 may execute software to control at least another component (e.g., hardware or software component) of the electronic device 101 connected to the processor 110, and may process and calculate various types of data. According to an embodiment, as at least part of data processing or calculation, the processor 110 may store instructions or data received from other components (e.g., the input module 130, the sensor module 161 or a communication module 173) into a volatile memory 121, may process instructions or data stored in the volatile memory 121. The result data may be stored in a nonvolatile memory 122.

The processor 110 may include a main processor 111 and an auxiliary processor 112. The main processor 111 may include one or more of a central processing unit (CPU) 111-1 or an application processor (AP). The main processor 111 may further include one or more of a graphic processing unit (GPU) 111-2, a communication processor (CP), and an image signal processor (ISP). The main processor 111 may further include a neural processing unit (NPU) 111-3. The NPU 111-3 may be a processor that is specialized in processing an artificial intelligence model. The artificial intelligence model may be generated through machine learning. The artificial intelligence model may include a plurality of artificial neural network layers. The artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of the networks, but may not be limited to the above-described example. In addition to a hardware structure, additionally or alternatively, the artificial intelligence model may include a software structure. At least two of the processing units and the processors that are described above may be implemented as one integrated component (e.g., a single chip) or may be implemented as independent components (e.g., a plurality of chips).

The auxiliary processor 112 may include a controller 112-1. The controller 112-1 may include an interface converting circuit and a timing control circuit. The controller 112-1 receives an image signal from the main processor 111, converts the data format of the image signal so as to be suitable for the interface specifications with the display module 140, and outputs image data. The controller 112-1 may output various control signals required to drive the display module 140.

The auxiliary processor 112 may further include a data converting circuit 112-2, a gamma correcting circuit 112-3, and a rendering circuit 112-4. The data converting circuit 112-2 may receive the image data from the controller 112-1 and may compensate for the image data such that an image is displayed at a desired luminance according to characteristics of the electronic device 101 or setting of the user or may convert the image data to reduce power consumption or compensate for afterimages. The gamma correcting circuit 112-3 may convert the image data, a gamma reference voltage, or the like such that the image displayed on the electronic device 101 has desired gamma characteristics. The rendering circuit 112-4 may receive the image data from the controller 112-1 and may render the image data in consideration of a pixel arrangement of the display panel 141 applied to the electronic device 101. At least one of the data converting circuit 112-2, the gamma correcting circuit 112-3, and the rendering circuit 112-4 may be integrated into another component (e.g., the main processor 111 or the driving controller 112-1). At least one of the data converting circuit 112-2, the gamma correcting circuit 112-3, and the rendering circuit 112-4 may be integrated into a data driver 143, which will be described below.

The memory 120 may store various pieces of data, which are used by at least one component (e.g., the processor 110 or the sensor module 161) of the electronic device 101 and input data or output data for commands related thereto. The memory 120 may include at least one or more of the volatile memory 121 and the nonvolatile memory 122.

The input module 130 may receive, from the outside (e.g., the user or the external electronic device 102) of the electronic device 101, commands or data to be used in a component (e.g., the processor 110, the sensor module 161, or the sound output module 163) of the electronic device 101.

The input module 130 may include a first input module 131, through which the commands or data are input from the user, and a second input module 132 through which the commands or data are input from the external electronic device 102. The first input module 131 may include a microphone, a mouse, a keyboard, a key (e.g., a button), or a pen (e.g., a passive pen or an active pen). The second input module 132 may support a designated protocol capable of being connected to the external electronic device 102 by wire or wirelessly. According to an embodiment, the second input module 132 may include a high definition multimedia interface (HDMI), a universal serial bus (USB) interface, a secure digital (SD) card interface, or an audio interface. The second input module 132 may include a connector that may be physically connected to the external electronic device 102, for example, an HDMI connector, a USB connector, an SD card connector, or an audio connector (e.g., a headphone connector).

The display module 140 provides visual information to the user. The display module 140 may include the display panel 141, a scan driver 142, and the data driver 143. The display module 140 may further include a window, a chassis, a bracket, or the like for protecting the display panel 141.

The display panel 141 may include a liquid crystal display panel, an organic light emitting display panel, or an inorganic light emitting display panel, and the type of the display panel 141 is not particularly limited thereto. The display panel 141 may be of a rigid type or a flexible type capable of being rolled or folded. The display module 140 may further include a supporter, a bracket, or a heat dissipation member that supports the display panel 141.

The scan driver 142 may be mounted on the display panel 141 as a driving chip. Moreover, the scan driver 142 may be integrated into the display panel 141. For example, the scan driver 142 may include an Amorphous Silicon TFT Gate driver circuit (ASG), a Low Temperature Polycrystalline Silicon (LTPS) TFT Gate driver circuit, or an Oxide Semiconductor TFT Gate driver circuit (OSG), which is embedded in the display panel 141. The scan driver 142 receives a control signal from the controller 112-1 and outputs scan signals to the display panel 141 in response to the control signal.

The display panel 141 may further include a light emitting driver. The light emitting driver outputs an emission control signal to the display panel 141 in response to the control signal received from the controller 112-1. The light emitting driver may be formed so as to be distinguished from the scan driver 142 or may be integrated into the scan driver 142.

The data driver 143 receives the control signal from the controller 112-1, converts image data into an analog voltage (e.g., a data voltage) in response to the control signal, and then outputs data voltages to the display panel 141.

The data driver 143 may be integrated into another component (e.g., the controller 112-1). The functions of an interface conversion circuit and a timing control circuit of the controller 112-1 described above may be integrated into the data driver 143.

The display module 140 may further include a light emitting driver, a voltage generation circuit, and the like. The voltage generation circuit may output various voltages required to operate the display panel 141.

The power supply module 150 supplies power to the components of the electronic device 101. The power supply module 150 may include a battery that charges a power voltage. The battery may include a non-rechargeable primary cell, a rechargeable secondary cell, a fuel cell, or the like. The power supply module 150 may include a power management integrated circuit (PMIC). The PMIC supplies optimized power to the above-described modules and modules which will be described below. The power supply module 150 may include a wireless power transmission/reception member electrically connected to the battery. The wireless power transmission/reception member may include a plurality of coil-shaped antenna radiators.

The electronic device 101 may further include the embedded module 160 and the external module 170. The embedded module 160 may include the sensor module 161, the antenna module 162, and the sound output module 163. The external module 170 may include the camera module 171, a light module 172, and the communication module 173.

The sensor module 161 may detect an input from the user's body or an input from a pen among the first input module 131, and may generate an electrical signal or data value corresponding to the input. The sensor module 161 may include at least one of the fingerprint sensor 161-1, the input sensor 161-2, and a digitizer 161-3.

The fingerprint sensor 161-1 may generate a data value corresponding to a fingerprint of the user. The fingerprint sensor 161-1 may include one of an optical-type fingerprint sensor, or a capacitance-type fingerprint sensor.

The input sensor 161-2 may generate a data value corresponding to coordinate information of an input by a body of the user or an input by a pen. The input sensor 161-2 generates the change in capacitance due to the input as the data value. The input sensor 161-2 may sense an input by a passive pen or may transmit or receive data to or from an active pen.

The input sensor 161-2 may also measure a biometric signal such as blood pressure, moisture, or body fat. For example, when the user touches a part of the body to a sensor layer or sensing panel and does not move during a specific period, the input sensor 161-2 may detect the biometric signal and may output information desired by the user to the display module 140 based on changes in electric fields caused by the part of the body.

The digitizer 161-3 may generate the data value corresponding to coordinate information of an input by the pen. The digitizer 161-3 generates an electromagnetic change amount due to the input as the data value. The digitizer 161-3 may sense input by the passive pen or transmit or receive data to or from the active pen.

At least one of the fingerprint sensor 161-1, the input sensor 161-2, and the digitizer 161-3 may be implemented as a sensor layer formed on the display panel 141 through a subsequent process. The fingerprint sensor 161-1, the input sensor 161-2, and the digitizer 161-3 may be placed on the upper side of the display panel 141, and one (e.g., the digitizer 161-3) of the fingerprint sensor 161-1, the input sensor 161-2, and the digitizer 161-3 may be placed on the lower side of the display panel 141.

At least two or more of the fingerprint sensor 161-1, the input sensor 161-2, and the digitizer 161-3 may be formed to be integrated into one sensing panel through the same process. When being integrated into one sensing panel, the sensing panel may be placed between the display panel 141 and a window placed on the upper side of the display panel 141. According to an embodiment, the sensing panel may be placed on a window, and the location of the sensing panel is not particularly limited thereto.

At least one of the fingerprint sensor 161-1, the input sensor 161-2, and the digitizer 161-3 may be built into the display panel 141. That is, at least one of the fingerprint sensor 161-1, the input sensor 161-2, and the digitizer 161-3 may be simultaneously formed through a process of forming elements (e.g., a light emitting element, a transistor, or the like) included in the display panel 141.

Besides, the sensor module 161 may generate an electrical signal or a data value corresponding to the internal state or external state of the electronic device 101. For example, the sensor module 161 may further include a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illumination sensor.

The antenna module 162 may include one or more antennas to transmit or receive the signal or power to or from an external source. According to an embodiment, the communication module 173 may transmit or receive the signal to or from the external electronic device through the antenna suitable for a communication method. An antenna pattern of the antenna module 162 may be integrated into the input sensor 161-2 or one component (e.g., the display panel 141) of the display module 140.

The sound output module 163 may be a device for outputting an audio signal to the outside of the electronic device 101 and, for example, may include a speaker used for general purposes, such as multimedia playback or recording playback, and a receiver used only for receiving a call. According to an embodiment, the receiver may be implemented separately from the speaker or may be integrated with the speaker. A sound output pattern of the sound output module 163 may be integrated into the display module 140.

The camera module 171 may shoot a still image or a video image. According to an embodiment, the camera module 171 may include one or more lenses, an image sensor, or an image signal processor. The camera module 171 may further include an infrared camera capable of measuring the presence or absence of the user, a position of the user, a gaze of the user, or the like.

The light module 172 may provide light. The light module 172 may include a light emitting diode or a xenon lamp. The light module 172 may operate in conjunction with the camera module 171 or may operate independently from the camera module 171.

The communication module 173 may support establishing a wired or wireless communication channel between the electronic device 101 and the external electronic device 102 and performing communication through the established communication channel. The communication module 173 may include one or all of wireless communication modules such as a cellular communication module, a short-range wireless communication module, or a global navigation satellite system (GNSS) communication module, or wired communication modules such as a local area network (LAN) communication module or a power line communication module. The communication module 173 may communicate with the external electronic device 102 through a short-range communication network such as Bluetooth, WiFi direct, or infrared data association (IrDA) or a long-range communication network such as a cellular network, Internet, or a computer network (e.g., the LAN or a wide area network (WAN)). The above-mentioned various communication modules 173 may be implemented into one chip or may be respectively implemented into separate chips.

The input module 130, the sensor module 161, the camera module 171, and the like may be utilized to control an operation of the display module 140 in conjunction with the processor 110.

The processor 110 outputs commands or data to the display module 140, the sound output module 163, the camera module 171, or the light module 172 based on input data received from the input module 130. For example, the processor 110 may generate image data in response to input data applied through a mouse, an active pen, or the like to output the generated image data to the display module 140 or may generate command data in response to the input data to output the generated command data to the camera module 171 or the light module 172. When no input data is received from the input module 130 during a specific period, the processor 110 may switch an operation mode of the electronic device 101 to a low-power mode or a sleep mode to reduce power consumed in the electronic device 101.

The processor 110 outputs commands or data to the display module 140, the sound output module 163, the camera module 171, or the light module 172 based on sensing data received from the sensor module 161. For example, the processor 110 may compare authentication data authorized by the fingerprint sensor 161-1 with the authentication data stored in the memory 120, and then may execute an application depending on the comparison result. The processor 110 may execute commands or may output corresponding image data to the display module 140 based on sensing data sensed by the input sensor 161-2 or the digitizer 161-3. When the sensor module 161 includes a temperature sensor, the processor 110 receives temperature data regarding the measured temperature from the sensor module 161 and may further perform luminance correction on image data based on the temperature data.

The processor 110 may receive measurement data regarding the presence or absence of the user, the user's location, and the user's gaze from the camera module 171. The processor 110 may further perform luminance correction on the image data based on the measurement data. For example, the processor 110 that determines the presence or absence of the user through an input from the camera module 171 may output image data, of which the luminance is corrected, to the display module 140 through the data converting circuit 112-2 or the gamma correcting circuit 112-3.

Some of the components may be connected to each other through communication methods between peripheral devices, for example, a bus, a general purpose input/output (GPIO), a serial peripheral interface (SPI), a mobile industry processor interface (MIPI), or an ultra-path interconnect (UPI) link and may exchange a signal (e.g., commands or data) between each other. The processor 110 may communicate with the display module 140 through a mutually promised interface, and for example, may use any one of the above-described communication methods, and the present disclosure is not limited to the above-described communication methods.

The electronic device 101 according to various embodiments disclosed in the specification may be implemented with various types of devices. The electronic device 101 may include, for example, at least one of a portable communication device (e.g., a smart phone), a computer device, a portable multimedia device, a portable medical device, a camera, a wearable device, or a home appliance. The electronic device 101 according to an embodiment of this specification may not be limited to the above-described devices.

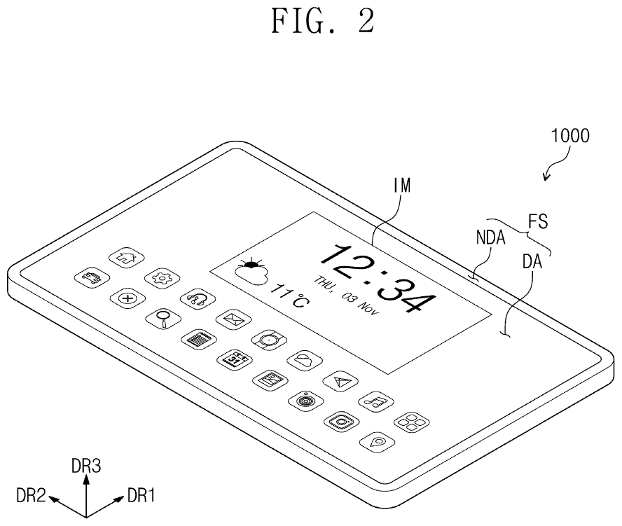

FIG. 2 is a perspective view of an electronic device 1000, according to an embodiment of the present disclosure.

Referring to FIG. 2, the electronic device 1000 may have a shape having short sides extending in a first direction DR1, and long sides extending in a second direction DR2 crossing the first direction DR1. However, the shape of the electronic device 1000 is not limited thereto. For example, the electronic device 1000 may be implemented in various shapes. The electronic device 1000 may be the same as the electronic device 101 of FIG. 1.

The electronic device 1000 may be a small and medium-sized display device, such as a mobile phone, a tablet, a vehicle navigation system, or a game console, as well as a large-sized electronic device, such as a television or a monitor. These are just presented as only an embodiment. It is obvious that these are capable of being employed in other electronic devices as long as these do not depart from the concept of the present disclosure.

As illustrated in FIG. 2, the electronic device 1000 may display an image IM on a display surface FS parallel to each of the first direction DR1 and the second direction DR2, and perpendicular to a third direction DR3. The display surface FS on which the image IM is displayed may correspond to a front surface of the electronic device 1000.

The display surface FS of the electronic device 1000 may be divided into a plurality of areas. A display area DA and a non-display area NDA may be defined in the display surface FS of the electronic device 1000.

The display area DA may be an area where the image IM is displayed, and a user may visually perceive the image IM through the display area DA. A shape of the display area DA may be defined substantially by the non-display area NDA. However, this is illustrated as an example. The non-display area NDA may be positioned to be adjacent to only one side of the display area DA or may be omitted. The electronic device 1000 according to an embodiment of the present disclosure may include various embodiments and is not limited to an embodiment.

The non-display area NDA may be an area adjacent to the display area DA, and may be an area in which the image IM is not displayed. The bezel area of the electronic device 1000 may be defined by the non-display area NDA.

The non-display area NDA may surround the display area DA. However, an embodiment is not limited thereto. For example, the non-display area NDA may be adjacent to only a portion of the edge of the display area DA and is not limited to an embodiment.

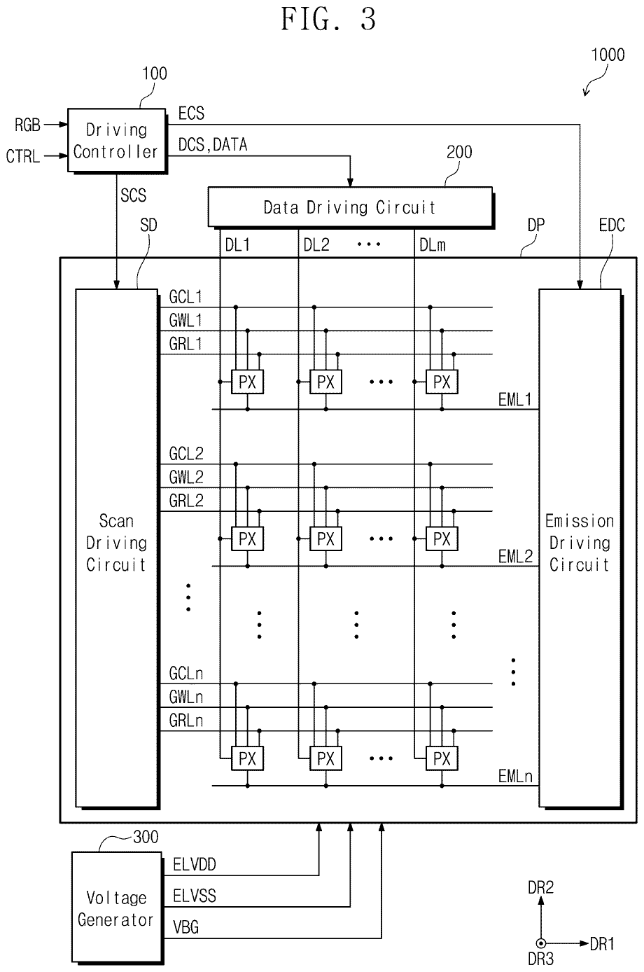

FIG. 3 is a block diagram of an electronic device 1000, according to an embodiment of the present disclosure.

Referring to FIG. 3, the electronic device 1000 may include a display panel DP, a driving controller 100, a data driving circuit 200, and a voltage generator 300.

The display panel DP according to an embodiment of the present disclosure may be a light emitting display panel, but is not particularly limited thereto. For example, the display panel DP may be an organic light emitting display panel, a quantum dot light emitting display panel, a micro-LED display panel, or a nano-LED display panel. A light emitting layer of the organic light emitting display panel may include an organic luminescent material. A light emitting layer of the quantum dot light emitting display panel may include a quantum dot, a quantum rod, or the like. A light emitting layer of the micro-LED display panel may include a micro-LED. A light emitting layer of the nano-LED display panel may include a nano-LED.

The display panel DP may be included in the display panel 141 (see FIG. 1) described in FIG. 1.

The driving controller 100 may receive an image signal RGB and a control signal CTRL. The driving controller 100 may generate an image data signal DATA by converting a data format of the image signal RGB so as to be suitable for the interface specification of the data driving circuit 200. The driving controller 100 may output a scan control signal SCS, a data control signal DCS, and an emission driving control signal ECS.

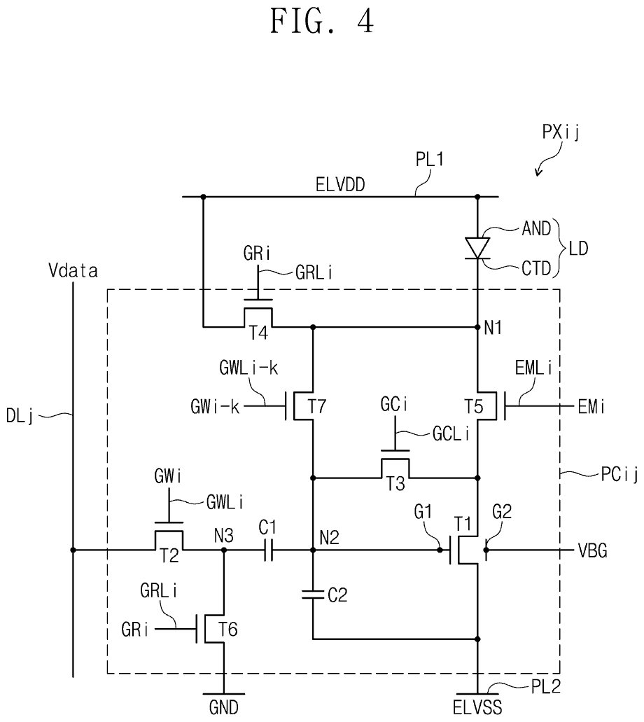

The data driving circuit 200 may receive the data control signal DCS and the image data signal DATA from the driving controller 100. The data driving circuit 200 may convert the image data signal DATA into data signals Vdata (see FIG. 4) and may output the data signals Vdata (see FIG. 4) to a plurality of data lines DL1 to DLm, respectively. The data signals Vdata (see FIG. 4) may be analog voltages corresponding to grayscale values of the image data signal DATA.

In an embodiment of the present disclosure, during a driving period of one frame, the data driving circuit 200 may output the data signals Vdata (see FIG. 4) corresponding to the image data signal DATA to the data lines DL1 to DLm, respectively.

The data driving circuit 200 may be included in the data driver 143 (see FIG. 1) described in FIG. 1.

The voltage generator 300 may generate voltages necessary to operate the display panel DP. In an embodiment of the present disclosure, the voltage generator 300 may generate a first power source ELVDD, a second power source ELVSS, and a lower gate voltage VBG. The voltage generator 300 may provide the first power source ELVDD, the second power source ELVSS, and the lower gate voltage VBG to the display panel DP. The voltage generator 300 may be included in the power supply module 150 (see FIG. 1) described in FIG. 1.

The display panel DP may include scan lines GCL1 to GCLn, GWL1 to GWLn, and GRL1 to GRLn, emission control lines EML1 to EMLn, the data lines DL1 to DLm, and a plurality of pixels PX. The display panel DP may further include a scan driving circuit SD and an emission driving circuit EDC.

The scan driving circuit SD and the emission driving circuit EDC may be included in the scan driver 142 (see FIG. 1) described in FIG. 1.

The scan driving circuit SD may be arranged on a first side of the display panel DP. The scan lines GCL1 to GCLn, GWL1 to GWLn, and GRL1 to GRLn may extend from the scan driving circuit SD in the first direction DR1.

The emission driving circuit EDC may be arranged on a second side of the display panel DP. The emission control lines EML1 to EMLn may extend from the emission driving circuit EDC in a direction opposite to the first direction DR1.

The scan lines GCL1 to GCLn, GWL1 to GWLn, and GRL1 to GRLn and the emission control lines EML1 to EMLn may be arranged spaced from one another in the second direction DR2.

The scan lines GCL1 to GCLn, GWL1 to GWLn, and GRL1 to GRLn may include the first scan lines GWL1 to GWLn, the second scan lines GRL1 to GRLn, and the third scan lines GCL1 to GCLn.

The data lines DL1 to DLm may extend from the data driving circuit 200 in a direction opposite to the second direction DR2. Each of the data lines DL1 to DLm may be arranged spaced from each other in the first direction DR1.

In the example shown in FIG. 3, the scan driving circuit SD and the emission driving circuit EDC are arranged to face each other with the pixels PX interposed therebetween, but the present disclosure is not limited thereto. For example, the scan driving circuit SD and the emission driving circuit EDC may be positioned adjacent to each other on one of the first side and the second side of the display panel DP. In an embodiment, the scan driving circuit SD and the emission driving circuit EDC may be implemented with one circuit.

The plurality of pixels PX may be electrically connected to the scan lines GCL1 to GCLn, GWL1 to GWLn, and GRL1 to GRLn, the emission control lines EML1 to EMLn, and the data lines DL1 to DLm. Each of the plurality of pixels PX may be electrically connected to three scan lines and one emission control line.

Each of the plurality of pixels PX may include a light emitting element LD (see FIG. 4) and a pixel driving circuit PCij (see FIG. 4) controlling light emission of the light emitting element LD (see FIG. 4).

The light emitting element LD (see FIG. 4) of each of the plurality of pixels PX may generate light of different colors. For example, the plurality of pixels PX may include red pixels generating red color light, green pixels generating green color light, and blue pixels generating blue color light. A light emitting element of a red pixel, a light emitting element of a green pixel, and a light emitting element of a blue pixel may include light emitting layers of different materials.

The pixel circuit unit may include at least one transistor and at least one capacitor. This will be described later. The scan driving circuit SD and the emission driving circuit EDC may include transistors formed through the same process as transistors of the pixel circuit unit.

Each of the plurality of pixels PX may receive the first power source ELVDD, the second power source ELVSS, and the lower gate voltage VBG from the voltage generator 300.

The scan driving circuit SD may receive the scan control signal SCS from the driving controller 100. The scan driving circuit SD may output scan signals to the scan lines GCL1 to GCLn, GWL1 to GWLn, and GRL1 to GRLn in response to the scan control signal SCS.

The emission driving circuit EDC may output emission signals to emission control lines EML1 to EMLn in response to the emission driving control signal ECS from the driving controller 100.

FIG. 4 is an equivalent circuit diagram of a pixel PXij, according to an embodiment of the present disclosure. Each of the plurality of pixels PX (see FIG. 3) shown in FIG. 3 may have the same circuit configuration as the equivalent circuit diagram of the pixel PXij shown in FIG. 4.

Referring to FIG. 4, the pixel PXij may be connected to a j-th data line DLj among the data lines DL1 to DLm, an i-th first scan line GWLi among the first scan lines GWL1 to GWLn, an i-th second scan line GRLi among the second scan lines GRL1 to GRLn, an i-th third scan line GCLi among the third scan lines GCL1 to GCLn, and an i-th emission control line EMLi among the emission control lines EML1 to EMLn. Here, each of ‘i’ and ‘j’ is a natural number.

The pixel PXij may include the light emitting element LD and the pixel driving circuit PCij. The light emitting element LD may be a light emitting diode. For example, the light emitting element LD may be an organic light emitting diode including an organic light emitting layer. The pixel driving circuit PCij may be connected to the light emitting element LD to control the amount of current flowing through the light emitting element LD. The light emitting element LD may generate light having a predetermined luminance depending on the amount of current thus received.

The pixel driving circuit PCij may include first to seventh transistors T1, T2, T3, T4, T5, T6, and T7 and capacitors C1 and C2.

The pixel PXij according to an embodiment of the present disclosure may be referred to as having a 7T2C structure.

Each of the first to seventh transistors T1 to T7 may be an N-type transistor by using an oxide semiconductor as a semiconductor layer. The oxide semiconductor may include a crystalline or amorphous oxide semiconductor. For example, the oxide semiconductor may include oxides of metals (e.g., zinc (Zn), indium (In), gallium (Ga), tin (Sn), titanium (Ti), and the like) or a mixture of the metals (e.g., zinc (Zn), indium (In), gallium (Ga), tin (Sn), titanium (Ti), and the like) and oxides of the metals. The oxide semiconductors may include indium-tin oxide (ITO), indium-gallium-zinc oxide (IGZO), zinc oxide (ZnO), indium-zinc oxide (IZO), zinc-indium oxide (ZIO), indium oxide (InO), titanium oxide (TiO), indium-zinc-tin oxide (IZTO), zinc-tin oxide (ZTO), and the like. However, this is an example, and the semiconductor layer according to an embodiment of the present disclosure is not limited thereto and may include amorphous silicon, low-temperature polycrystalline silicon (LTPS), crystalline silicon, or the like. Each of the first to seventh transistors T1 to T7 implemented as an N-type has a relatively small change in element characteristics or rate at which afterimages occur instantaneously. However, this is an example, and all of the first to seventh transistors T1 to T7 according to an embodiment of the present disclosure may be P-type transistors. In an embodiment, at least one of the first to seventh transistors T1 to T7 may be an N-type transistor, and the others thereof may be P-type transistors.

The i-th scan lines GCLi, GWLi, and GRLi may deliver i-th scan signals GCi, GWi, and GRi, respectively, and the i-th emission control line EMLi may deliver an i-th emission signals EMi. The data line DLj may deliver a data signal Vdata. The data signal Vdata may have a voltage level corresponding to the image signal RGB (see FIG. 3).

A first power source line PL1 may provide the first power source ELVDD. A second power source line PL2 may provide the second power source ELVSS. The second power source ELVSS may have a lower voltage level than the first power source ELVDD.

The light emitting element LD may be connected between the first power source line PL1, through which the first power source ELVDD is provided, and a first node N1. The light emitting element LD may include an anode AND and a cathode CTD. The anode AND may be directly connected to the first power source line PL1. The cathode CTD may be electrically connected to a second power source line PL2 via the fifth transistor T5 and the first transistor T1.

When the light emitting element LD is an organic light emitting element, the light emitting element LD may further include an organic layer positioned between the anode AND and the cathode CTD. The cathode CTD of the light emitting element LD may be connected to the pixel driving circuit PCij through the first node N1. The light emitting element LD may emit light in response to the amount of the driving current flowing through the first transistor T1 of the pixel driving circuit PCij.

The first transistor T1 may include a first electrode electrically connected to the first node N1 via the fifth transistor T5, a second electrode connected to the second power source line PL2 to which the second power source ELVSS is provided, a first gate electrode G1 connected to a second node N2, and a second gate electrode G2 to which the lower gate voltage VBG is provided.

The first electrode may be referred to as a “drain”, and the second electrode may be referred to as a “source”.

The first gate electrode G1 may be placed on the second gate electrode G2. The first gate electrode G1 may be referred to as an “upper gate electrode”, and the second gate electrode G2 may be referred to as a “lower gate electrode”. The first transistor T1 may have a dual gate structure. The first transistor T1 may be referred to as a “driving transistor”. Different voltages may be applied to the first gate electrode G1 and the second gate electrode G2. The voltage obtained by subtracting the voltage of the second electrode from the voltage of the second gate electrode G2 may have a negative voltage level. For example, the voltage obtained by subtracting the second power source ELVSS from the lower gate voltage VBG may have a negative voltage level.

According to an embodiment of the present disclosure, the first transistor T1 may be an N-type transistor. The cathode CTD of the light emitting element LD may be connected to a drain (or the first electrode) of the first transistor T1. In this case, even when the light emitting element LD deteriorates, the voltage of a source terminal (or a second electrode) of the first transistor T1 may not shift. That is, even when the light emitting element LD deteriorates, an upper gate-source voltage (referred to as “Vgs”) and a lower gate-source voltage of the first transistor T1 may not change. The upper gate-source voltage may be a voltage between the first gate electrode G1 and the source. The lower gate-source voltage may be a voltage between the second gate electrode G2 and the source. Accordingly, because the range of a change in the amount of current flowing through the first transistor T1 is reduced even when the usage time of the pixel PX increases, the afterimage defect (or poor long-term afterimage) of the display panel DP (see FIG. 3) may be reduced and the lifespan of the display panel DP (see FIG. 3) may be improved. Accordingly, the pixel PXij with improved display quality and the electronic device 1000 (see FIG. 2) including the same may be provided.

The second transistor T2 may include a first electrode electrically connected to the data line DLj to which the data signal Vdata is provided, a second electrode connected to a third node N3, and a gate electrode receiving the first scan signal GWi. The gate electrode may be connected to the first scan line GWLi. The second transistor T2 may be referred to as a “switch transistor”.

The third transistor T3 may include a first electrode connected to the second node N2, a second electrode connected to the first electrode of the first transistor T1, and a gate electrode receiving the third scan signal GCi. The gate electrode may be connected to the third scan line GCLi. The third transistor T3 may be referred to as a “compensation transistor”.

The fourth transistor T4 may include a first electrode connected to the first power source line PL1, a second electrode electrically connected to the first node N1, and a gate electrode receiving the second scan signal GRi. The gate electrode may be connected to the second scan line GRLi.

The fifth transistor T5 may include a first electrode connected to the first node N1, a second electrode connected to the first electrode of the first transistor T1, and a gate electrode receiving the emission signal EMi. The gate electrode may be connected to the emission control line EMLi.

The sixth transistor T6 may include a first electrode connected to the third node N3, a second electrode connected to a ground electrode GND provided with a ground voltage, and a gate electrode receiving the second scan signal GRi. The gate electrode may be connected to the second scan line GRLi.

The seventh transistor T7 may include a first electrode connected to the first node N1, a second electrode connected to the second node N2, and a gate electrode receiving a first scan signal GWi-k shifted by a predetermined time. The first scan signal GWi-k shifted by the predetermined time may be an (i-k)-th first scan signal GWi-k. The gate electrode may be connected to the (i-k)-th first scan line GWLi-k. Here, “k” may be a natural number.

The first capacitor C1 may be connected between the second node N2 and the third node N3. The first capacitor C1 may include a first electrode connected to the first gate electrode G1 of the first transistor T1 and a second electrode connected to the second transistor T2.

The second capacitor C2 may be connected between the second node N2 and the second power source line PL2. The second capacitor C2 may include a first electrode and a second electrode. The first electrode of the second capacitor C2 may be connected to the first gate electrode G1 of the first transistor T1.

The second electrode of the second capacitor C2 may be implemented as the second power source line PL2. The second power source line PL2 may have an area larger than other lines. The second capacitor C2 may have a higher storage capacity than the first capacitor C1. The second capacitor C2 may minimize a voltage change of the second node N2 in response to a voltage change of the third node N3. The second capacitor C2 may be referred to as a “hold capacitor”.

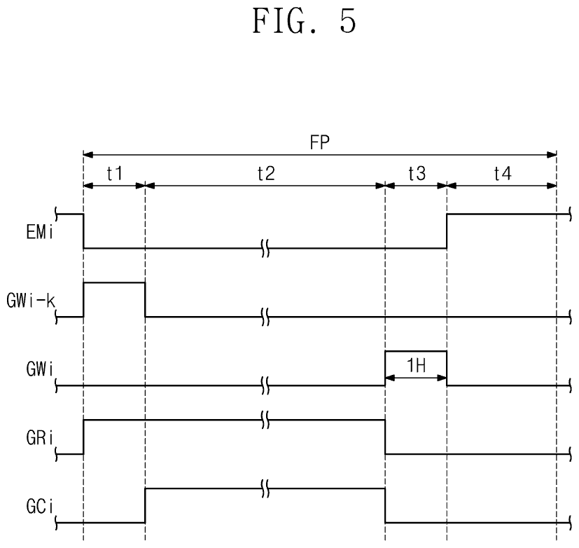

FIG. 5 is a timing diagram for describing an operation of an electronic device, according to an embodiment of the present disclosure.

Referring to FIG. 5, the display panel DP (see FIG. 3) may display the image IM (see FIG. 2) by operating in units of frame period FP. Any one frame period FP may include first to fourth periods t1, t2, t3, and t4. The first to third periods t1, t2, and t3 may be referred to as “non-emission periods”, and the fourth period t4 may be referred to as an “emission period”.

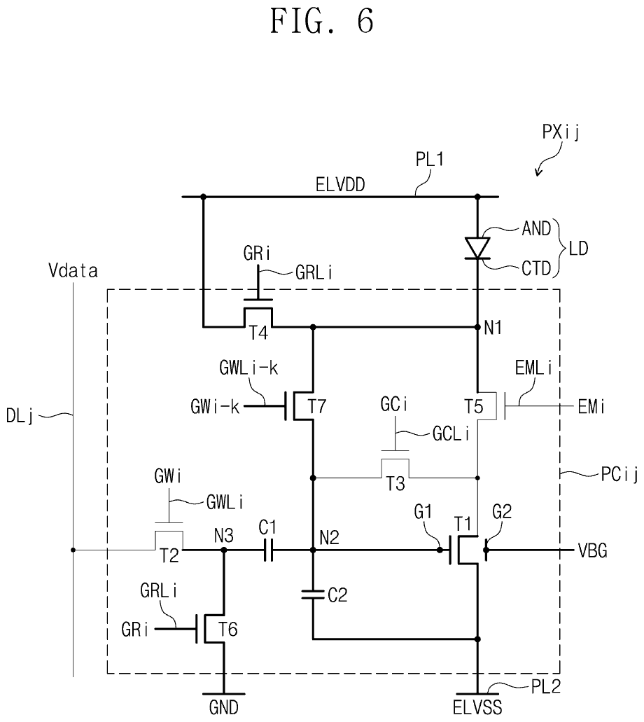

FIG. 6 is a diagram for describing an operation of a pixel, according to an embodiment of the present disclosure. In the description of FIG. 6, the same reference numerals are assigned to the same components described with reference to FIG. 4, and thus the descriptions thereof are omitted.

FIG. 6 is a diagram for describing an operation of the pixel PXij in the first period t1 of the frame period FP.

Referring to FIGS. 5 and 6, in the first period t1, the (i-k)-th first scan signal GWi-k and the second scan signal GRi may be at active levels. The active levels of the (i-k)-th first scan signal GWi-k and the second scan signal GRi may be high levels.

The emission signal EMi, the first scan signal GWi, and the third scan signal GCi may be at inactive levels. The inactive level of each of the emission signal EMi, the first scan signal GWi, and the third scan signal GCi may be a low level.

The fourth transistor T4 may be turned on in response to the second scan signal GRi. The first power source ELVDD may be provided to the first node N1 through the fourth transistor T4.

During the first period t1, the cathode CTD of the light emitting element LD may be initialized with the first power source ELVDD.

The seventh transistor T7 may be turned on in response to the (i-k)-th first scan signal GWi-k. The first power source ELVDD may be provided to the second node N2 through the fourth transistor T4 and the seventh transistor T7.

The (i-k)-th first scan signal GWi-k may be toggled during a horizontal period 1H. The horizontal period 1H may be defined as a period of the horizontal period signal provided to the display panel DP. That is, the first period t1 may be defined by the horizontal period 1H.

During the first period t1, the first gate electrode G1 of the first transistor T1 may be initialized with the first power source ELVDD. That is, the voltage of the second node N2 may change from the data signal Vdata of the previous frame period to the first power source ELVDD.

The sixth transistor T6 may be turned on in response to the second scan signal GRi. The ground voltage may be provided to the third node N3 through the sixth transistor T6.

The voltage of the third node N3 may change from the data signal Vdata of the previous frame period to the ground voltage.

According to an embodiment of the present disclosure, the fifth transistor T5 may be turned off in response to the emission signal EMi. For this reason, the light emitting element LD and the first transistor T1 are not connected to each other, and no current may flow between the light emitting element LD and the first transistor T1 during the first period t1. Accordingly, the electronic device 1000 (see FIG. 3) with reduced power consumption may be provided.

The first period t1 may be referred to as an “initialization period”.

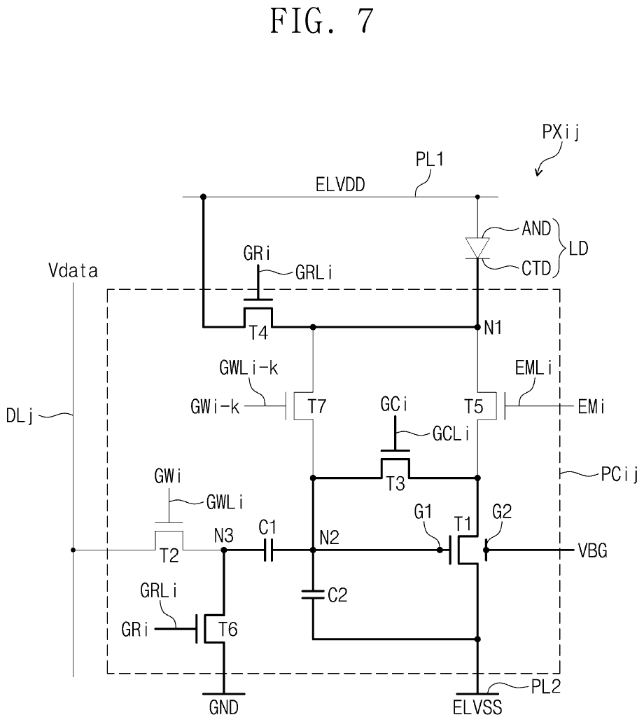

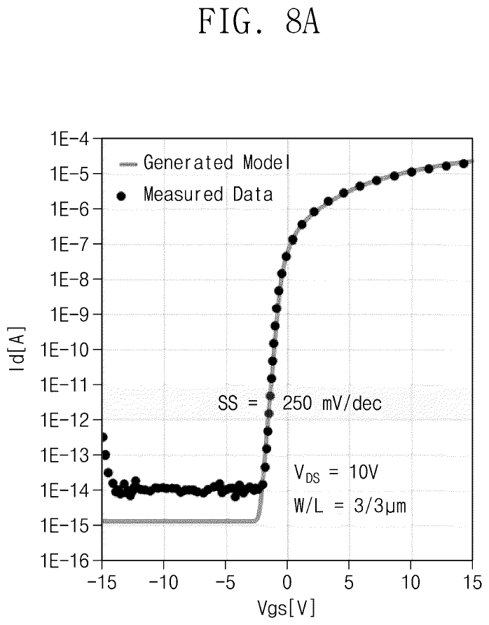

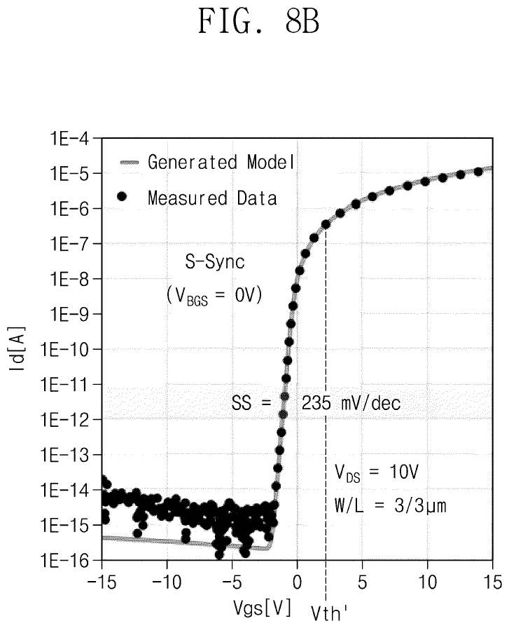

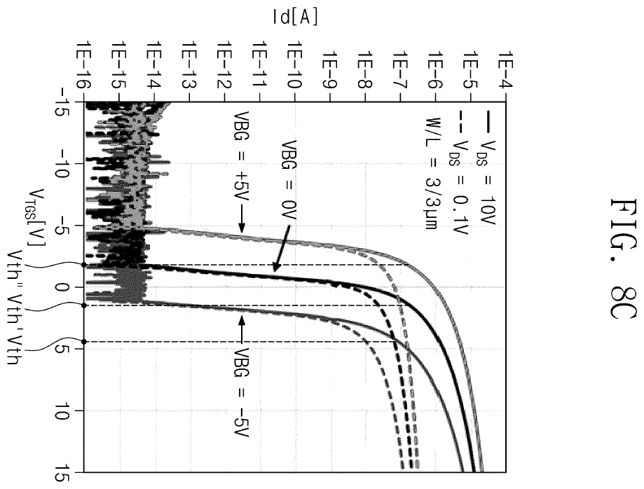

FIG. 7 is a diagram for describing an operation of the pixel PXij, according to an embodiment of the present disclosure. FIGS. 8A to 8C are graphs illustrating characteristics of a transistor, according to an embodiment of the present disclosure.

FIG. 7 is a diagram for describing an operation of the pixel PXij in the second period t2 of the frame period FP. In the description of FIG. 7, the same reference numerals are assigned to the same components described with reference to FIG. 4, and thus the descriptions thereof are omitted.

Referring to FIGS. 5 and 7 to 8C, the second period t2 may be continuous with the first period t1.

In the second period t2, the second scan signal GRi and the third scan signal GCi may be at active levels. The active level of each of the second scan signal GRi and the third scan signal GCi may be a high level.

The emission signal EMi and the first scan signals GWi and GWi-k may be at inactive levels. The inactive level of each of the emission signal EMi and the first scan signals GWi and GWi-k may be a low level.

The fourth transistor T4 may be turned on in response to the second scan signal GRi. The first power source ELVDD may be provided to the first node N1 through the fourth transistor T4.

The sixth transistor T6 may be turned on in response to the second scan signal GRi. The ground voltage may be provided to the third node N3 through the sixth transistor T6.

The third transistor T3 may be turned on in response to the third scan signal GCi. The first transistor T1 may be turned on in response to the first power source ELVDD provided to the first gate electrode G1.

The lower gate voltage VBG may be applied to the second gate electrode G2 of the first transistor T1. The voltage obtained by subtracting a source voltage from the voltage of the second gate electrode G2 may have a negative voltage level. For this reason, the first transistor T1 may have enhancement mode characteristics.

As the third transistor T3 is turned on, the first gate electrode G1 and the drain electrode of the first transistor T1 may be connected to each other. The first transistor T1 may operate in a diode-connected structure. For this reason, the threshold voltage (referred to as “Vth”) of the first transistor T1 may be extracted.

When the upper gate-source voltage of the first transistor T1 is equal to the threshold voltage of the first transistor T1, the first transistor T1 may be turned off. The upper gate-source voltage may be a voltage between the first gate electrode G1 and the source.

The second capacitor C2 may be connected to the second node N2. One electrode of the second capacitor C2 may be connected to the second power source line PL2, which receives the second power source ELVSS. The second node N2 may be provided with a voltage “ELVSS+Vth” as high as the threshold voltage of the first transistor T1 from the second power source ELVSS.

The second capacitor C2 may store charges corresponding to a voltage difference between the second power source ELVSS and the second node N2.

According to an embodiment of the present disclosure, one electrode of the second capacitor C2 may be implemented as the second power source line PL2. The second power source line PL2 may have an area larger than other lines. Because the second capacitor C2 is implemented with the second power source line PL2 capable of having an area larger than other lines, the area efficiency may increase. The second capacitor C2 may easily store the extracted threshold voltage of the first transistor T1. Because the change in the characteristics of the light emitting element LD does not affect the upper gate-source voltage and the lower gate-source voltage of the first transistor T1, a threshold voltage may be compensated accurately. Accordingly, the electronic device 1000 (see FIG. 3) having improved reliability may be provided.

FIG. 8A is a graph showing a characteristic conversion curve of a second transistor, according to an embodiment of the present disclosure. FIGS. 8B and 8C are graphs showing characteristic conversion curves of a first transistor, according to an embodiment of the present disclosure.

Referring to FIGS. 7 to 8C, a horizontal axis of each of graphs may represent an upper gate-source voltage and a lower gate-source voltage of each of the transistors T1 and T2. The unit of the horizontal axis may be a voltage (V).

A vertical axis of each of the graphs may represent the drain-source current of each of the transistors T1 and T2. The unit of the vertical axis may be an ampere (A). The drain-source current may be expressed based on Equation 1.

$$Id = \frac{1}{2} \cdot μ \cdot Cox \cdot \frac{W}{L} ( V gs - V th ) \qquad [ Equation 1 ]$$

In Equation 1, μ may denote electric field mobility; Cox may denote the capacitance of a gate insulating film; W/L may denote the width and length of the transistors T1 and T2; and, Vgs may denote an upper gate-source voltage of the transistors T1 and T2. μ and Cox may be constants. For example, in each of the graphs, W/L may be 3/3 micrometers (μm).

FIG. 8A may be a graph illustrating characteristics of the second transistor T2. The second transistor T2 may have a single-gate structure with one gate electrode. Each of the second to seventh transistors T2 to T7 according to an embodiment of the present disclosure may have a single-gate structure. However, this is an example, and each of the second to seventh transistors T2 to T7 according to an embodiment of the present disclosure may have a double-gate structure having two gate electrodes. In the case, the same voltage may be applied to each of an upper gate and a lower gate.

The graph in FIG. 8A shows measured data and simulation data (a generated model) of the second transistor T2.

The semiconductor layer of the second transistor T2 may include an oxide semiconductor. The oxide semiconductor may have faster electron mobility than an amorphous silicon semiconductor. The oxide semiconductor may have the relatively fast response speed.

The oxide semiconductor may have higher uniformity than an LTPS semiconductor. Moreover, the oxide semiconductor may have manufacturing costs less expensive than the LTPS semiconductor. For this reason, the oxide semiconductor may be advantageous in manufacturing the electronic device 1000 (see FIG. 2) having a large-sized screen.

The subthreshold swing (referred to as “SS”) of the oxide semiconductors may be smaller than that of the amorphous silicon semiconductor and the LTPS silicon semiconductor. The subthreshold swing of a transistor may be defined as an increase in gate voltage required to increase the current by 10 times. The unit of the subthreshold swing may be mV/dec. For example, the subthreshold swing of the second transistor T2 may be 250 mV/dec.

According to an embodiment of the present disclosure, the oxide semiconductor may have lower leakage current than the amorphous silicon semiconductor and the LTPS silicon semiconductor. The electronic device 1000 (see FIG. 2) may implement low refresh rate operation by lowering a screen refresh rate based on a low leakage current. Accordingly, the power consumption of the electronic device 1000 (see FIG. 2) may be reduced.

In the measured data and the simulation data (the generated model) of the second transistor T2, the drain-source voltage (referred to as “VDs”) of the second transistor T2 may be defined as 10 V.

FIGS. 8B and 8C may be graphs illustrating characteristics of the first transistor T1. The first transistor T1 may have a double-gate structure with the two gate electrodes G1 and G2. Different voltages may be applied to the two gate electrodes G1 and G2. The graph in FIG. 8B shows measured data and simulation data (a generated model) of the first transistor T1.

The semiconductor layer of the first transistor T1 may include an oxide semiconductor.

The subthreshold swing of the first transistor T1 may be 235 mV/dec.

In the measured data and the simulation data (the generated model) of the first transistor T1, the drain-source voltage of the first transistor T1 may be defined as 10 V.

According to a comparative example of the present disclosure, 0 V may be applied between the second gate electrode G2 and the source of the first transistor T1. The voltage provided between the second gate electrode G2 and the source may be referred to as “V_{BGS}”. In this case, a threshold voltage Vth′ of the first transistor T1 may have a positive value adjacent to 0.

FIG. 8C shows the characteristics of the first transistor T1 according to a voltage applied between the second gate electrode G2 and the source, and a drain-source voltage.

The graph in FIG. 8C is drawn with a solid line when the drain-source voltage of the first transistor T1 is 10 V, and with a dotted line when the drain-source voltage is 0.1 V.

The graph in FIG. 8C shows the characteristics of the first transistor T1 measured when the voltages applied between the second gate electrode G2 and the source are +5 V, 0 V, and −5 V.

+5 V may be applied to the second gate electrode G2 of the first transistor T1 according to a comparative example of the present disclosure. In this case, the threshold voltage Vth″ of the first transistor T1 may have a negative value. The first transistor T1 may operate in a depletion mode.

0 V may be applied to the second gate electrode G2 of the first transistor T1 according to a comparative example of the present disclosure. In this case, a threshold voltage Vth′ of the first transistor T1 may have a value adjacent to 0. The first transistor T1 may operate in one of the depletion mode or the enhancement mode.

According to an embodiment of the present disclosure, the voltage obtained by subtracting the second power source ELVSS from the lower gate voltage VBG may have a negative voltage level. The lower gate voltage VBG may be applied to the second gate electrode G2 of the first transistor T1. −5 V may be applied to the second gate electrode G2 of the first transistor T1. In this case, a threshold voltage Vth′ of the first transistor T1 may have a positive value. The first transistor T1 may operate in the enhancement mode.

Unlike an embodiment of the present disclosure, when the first transistor T1 is in the depletion mode when the threshold voltage of the first transistor T1 is extracted through the diode connection structure during the second period t2, the threshold voltage may not be stored in the second node N2, and the current may stop at the same level as the level of the drain-source voltage, thereby making the compensation of the threshold voltage impossible. However, according to an embodiment of the present disclosure, the voltage obtained by subtracting the second power source ELVSS applied to the source from the lower gate voltage VBG applied to the second gate electrode G2 of the first transistor T1 may have a negative voltage level, thereby guaranteeing the enhancement mode of the first transistor T1. When the upper gate-source voltage of the first transistor T1 is equal to the threshold voltage of the first transistor T1 in the enhancement mode, the first transistor T1 may be turned off. During the second period t2, the threshold voltage of the first transistor T1 may be easily extracted. Accordingly, the electronic device 1000 (see FIG. 2) having improved reliability may be provided.

Returning to FIGS. 5 and 7, the toggle time of each of the first scan signals GWi and GWi-k may be restricted to the horizontal cycle 1H, which is a data input time, so as to provide a data signal Vdata, by the resolution and screen refresh rate of the display panel DP (see FIG. 3).

In the second period t2 according to an embodiment of the present disclosure, the first scan signals GWi and GWi-k may be at inactive levels. For this reason, the length of the second period t2 may not be restricted by the data input time. For example, the second period t2 may be ten times the horizontal period 1H.

TABLE 1

| | 10 pico- | | | 1 nano- | | |
|---|---|---|---|---|---|---|
| | Amperes | | | Amperes | | |
| Driving current | (pA) | 100 pA | | (nA) | 10 nA | 30 nA |
| ΔSS_{T1} = −5% | 7.09 pA | 82.1 | pA | 0.92 nA | 9.82 nA | 29.5 nA |
| Error | −29% | −19% | | −7.1% | −1.8% | 0.0% |
| ΔSS_{T1} = 0% | 9.95 pA | 101 | pA | 0.99 nA | 10.0 nA | 29.5 nA |
| Error | 54% | 31% | | 11% | 3.0% | −0.3% |
| ΔSS_{T1} = +5% | 15.3 pA | 132 | pA | 1.10 nA | 10.3 nA | 29.4 nA |

Table 1 may show errors and results, which are obtained by simulating a driving current according to the deviation of the subthreshold swing of the first transistor T1 having ±5%, when a length of the second period t2 according to the comparative example of the present disclosure is 2.8 microseconds (us). The errors refer to current errors between a value of a lower cell and a value of an upper cell in Table 1. When the threshold voltage of the first transistor T1 is shortly extracted for the horizontal period 1H of 2.8 us during the second period t2, it may be difficult to extract the characteristics of the first transistor T1 for a low current level. This may cause a high current error depending on the deviation of the subthreshold swing of the first transistor T1.

TABLE 2

| Driving current | 10 pA | 100 pA | | 1 nA | 10 nA | 30 nA |
|---|---|---|---|---|---|---|
| ΔSS_{T1} = −5% | 8.02 pA | 91.7 | pA | 1.00 nA | 10.9 nA | 30.9 nA |
| Error | −22% | −12% | | −2.9% | 0.0% | 1.3% |
| ΔSS_{T1} = 0% | 10.3 pA | 104 | pA | 1.03 nA | 10.9 nA | 30.5 nA |
| Error | 38% | 18% | | 4.9% | 0.0% | −2.0% |
| ΔSS_{T1} = +5% | 14.2 pA | 123 | pA | 1.08 nA | 10.9 nA | 29.9 nA |

Table 2 may show errors and results, which are obtained by simulating a driving current according to the deviation of the subthreshold swing of the first transistor T1 having ±5%, when a length of the second period t2 according to an embodiment of the present disclosure is 2.8 us. The errors refer to current errors between a value of a lower cell and a value of an upper cell in Table 1. According to an embodiment of the present disclosure, during the second period t2, the threshold voltage of the first transistor T1 may be extracted for 10H of 28 us. The characteristics of the first transistor T1 may be extracted more accurately at a low current level. In an operation in which a driving current of 1 nA flows, the error may be reduced to less than 5%. Even in an operation where driving currents of 10 pA and 100 pA flow, the error may be reduced compared to the case where the length of the second period t2 is 2.8 us.

According to an embodiment of the present disclosure, the second period t2 may secure sufficient time required to accurately extract the threshold voltage of the first transistor T1. The driving current flowing through the light emitting element LD during an emission period may be determined independently of the threshold voltage of the first transistor T1 by compensating for the threshold voltage during the frame period FP. Stains on the image IM (see FIG. 2) due to the characteristic deviation of the first transistor T1 of each of the plurality of pixels PX (see FIG. 3) may be prevented or removed. In particular, stains in the image IM (see FIG. 2) at a low grayscale level having a low driving current may be prevented or removed. Accordingly, the electronic device 1000 (see FIG. 3) with improved display quality and reliability may be provided.

The second period t2 may be referred to as a “threshold voltage extraction period” or a “compensation period”.

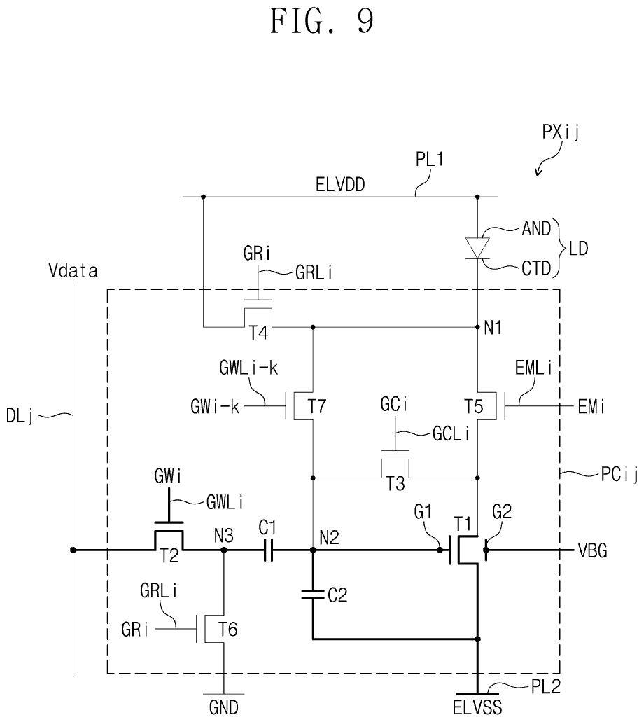

FIG. 9 is a diagram for describing an operation of a pixel, according to an embodiment of the present disclosure. In the description of FIG. 9, the same reference numerals are assigned to the same components described with reference to FIG. 4, and thus the descriptions thereof are omitted.

Referring to FIGS. 5 and 9, in the third period t3, the first scan signal GWi may be at an active level. The active level of the first scan signal GWi may be a high level.

The (i-k)-th first scan signal GWi-k, the emission signal EMi, the second scan signal GRi, and the third scan signal GCi may be at inactive levels. The inactive level of each of the (i-k)-th first scan signal GWi-k, the emission signal EMi, the second scan signal GRi, and the third scan signal GCi may be a low level.

The first scan signal GWi may be toggled during the horizontal period 1H. That is, the third period t3 may be defined by the horizontal period 1H.

The third transistor T3 may be turned off. The second node N2 may be in a floating state.

The second transistor T2 may be turned on in response to the first scan signal GWi. The data signal Vdata provided through the data line DLj may be provided to the third node N3.

The data signal Vdata may be delivered to the second node N2 through a voltage distribution operation of the first capacitor C1 and the second capacitor C2. In other words, the distributed data signal Vdata may be provided to the first gate electrode G1 of the first transistor T1.

The distributed data signal Vdata may be added to a voltage “ELVSS+Vth” provided in the second period t2 at the second node N2. In the third period t3, a voltage corresponding to Equation 2 may be provided to the second node N2.

$$EL V SS + V th + \frac{C 1}{C 1 + C 2} V data \qquad [ Equation 2 ]$$

The third period t3 may be referred to as a “write period”.

TABLE 3

| Driving current = 1 nA | Comparative examples | Embodiments |
|---|---|---|
| ΔVₜₕ_{_{—}}_{T2} = −0.5 V | 1.04 nA | 1.03 nA |
| Error | −4.6% | 0.0% |
| ΔVₜₕ_{_{—}}_{T2} = 0 V | 1.09 nA | 1.03 nA |
| Error | 4.6% | −1.9% |
| ΔVₜₕ_{_{—}}_{T2} = +0.5 V | 1.14 nA | 1.01 nA |

Table 3 shows an error and a driving current flowing through the first transistor T1 according to the deviation of the threshold voltage of the second transistor T2 according to a comparative example and an embodiment of the present disclosure.

TABLE 4

| Driving current = 1 nA | Comparative examples | Embodiments |
|---|---|---|
| ΔVₜₕ_{_{—}}_{T3} = −0.5 V | 0.86 nA | 0.93 nA |
| Error | −21% | −9.7% |
| ΔVₜₕ_{_{—}}_{T3} = 0 V | 1.09 nA | 1.03 nA |
| Error | 25% | 11% |
| ΔVₜₕ_{_{—}}_{T3} = +0.5 V | 1.36 nA | 1.14 nA |

Table 4 shows an error and a driving current flowing through the first transistor T1 according to the deviation of the threshold voltage of the third transistor T3 according to a comparative example and an embodiment of the present disclosure. Comparative examples in Tables 3 and 4 refer to configurations in which the second capacitor C2 is connected between the third node N3 and the second power source line PL2. In this case, no voltage distribution occurs in the data signal Vdata provided to the second node N2.

Embodiments of Table 3 and Table 4 refer to configurations in which the second capacitor C2 is connected between the second node N2 and the second power source line PL2, as shown in FIG. 9. The data signal Vdata may be distributed by the first capacitor C1 and the second capacitor C2.

According to an embodiment of the present disclosure, even when a deviation in the threshold voltages of the second transistor T2 and the third transistor T3 occurs, an error in the driving current flowing in the first transistor T1 may be reduced in an operation in which a driving current of 1 nA flows by the voltage distribution of the data signal Vdata. That is, even when there is a deviation in characteristics of the switching transistor and the compensation transistor, the driving current flowing to the driving transistor may be provided relatively uniformly. Accordingly, the electronic device 1000 (see FIG. 3) with improved display quality may be provided.

TABLE 5

| Driving current | 100 pA | 1 nA | 10 nA |
|---|---|---|---|
| Comparative | 1.28 V | 1.66 V | 2.45 V |
| examples | | | |
| Embodiments | 0.98 V | 1.85 V | 3.80 V |

Table 5 shows the data signal Vdata delivered to the second node N2 according to a comparative example and an embodiment of the present disclosure when the length of the second period t2 is 10H. A comparative example in Table 5 refers to a configuration in which the second capacitor C2 is connected between the third node N3 and the second power source line PL2. In this case, no voltage distribution occurs in the data signal Vdata provided to the second node N2.

Embodiments of Table 5 refer to configurations in which the second capacitor C2 is connected between the second node N2 and the second power source line PL2, as shown in FIG. 9. The data signal Vdata may be distributed by the first capacitor C1 and the second capacitor C2.

In the driving current range of 100 pA to 10 nA, a voltage range of the data signal Vdata provided to the second node N2 of the comparative example may be 1.17 V, and a voltage range of the data signal Vdata provided to the second node N2 of an embodiment of the present disclosure may be 2.82 V.

That is, compared to a pixel circuit without a voltage distribution operation, a pixel circuit PCij according to an embodiment of the present disclosure may have a voltage range of the data signal Vdata expanded by about 2.4 times.

According to an embodiment of the present disclosure, a voltage corresponding to the data signal Vdata may be distributed by the first capacitor C1 and the second capacitor C2. The data voltage range may be expanded by the distributed voltage of the data signal Vdata. For this reason, a current error of the first transistor T1 may be reduced. Furthermore, the load on the data driving circuit 200 (see FIG. 3) may be reduced. Accordingly, the electronic device 1000 (see FIG. 3) having improved reliability may be provided.

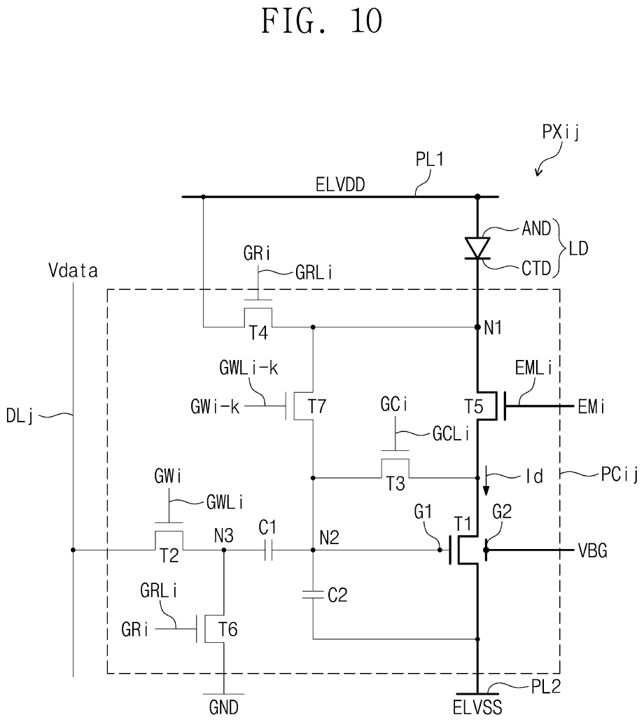

FIG. 10 is a diagram for describing an operation of a pixel PXij, according to an embodiment of the present disclosure. In the description of FIG. 10, the same reference numerals are assigned to the same components described with reference to FIG. 4, and thus the descriptions thereof are omitted.

Referring to FIGS. 5 and 10, the emission signal EMi may be at an active level in the fourth period t4. The active level of the emission signal EMi may be a high level.

The first scan signal GWi, the (i-k)-th first scan signal GWi-k, the second scan signal GRi, and the third scan signal GCi may be at inactive levels. The inactive level of each of the first scan signal GWi, the (i-k)-th first scan signal GWi-k, the second scan signal GRi, and the third scan signal GCi may be a low level.

The fifth transistor T5 may be turned on in response to the emission signal EMi. As the fifth transistor T5 is turned on, a current path may be formed from the first power source line PL1 to the light emitting element LD, the fifth transistor T5, the first transistor T1, and the second power source line PL2. That is, a driving current Id may flow from the first power source line PL1 via the light emitting element LD, the fifth transistor T5, the first transistor T1, and the second power source line PL2.

The fourth period t4 may be referred to as an “emission period”.

The data signal Vdata output from the data driving circuit 200 (see FIG. 3) of the display panel DP (see FIG. 3) are written, and thus the light emitting element LD may emit light. The driving current Id may be expressed by the following equations.

$$V gs = [ EL V SS + V th + \frac{C 1}{C 1 + C 2} V data - EL V SS ] \qquad [ Equation 3 ]$$

$$Id = \frac{1}{2} \cdot μ \cdot Cox \cdot \frac{W}{L} {[ EL V SS + V th + \frac{C 1}{C 1 + C 2} V data - EL V SS - V th ]}^{2} \qquad [ Equation 4 ]$$

$$Id = \frac{1}{2} \cdot μ \cdot Cox \cdot \frac{W}{L} {( \frac{C 1}{C 1 + C 2} V data )}^{2} \qquad [ Equation 5 ]$$

Equation 5 may be a summary of Equation 4 obtained by reflecting Equation 3 to Equation 1.

The threshold voltage Vth of the first transistor T1 included in each of the pixels PXij may be different depending on characteristics of the first transistor T1. However, according to an embodiment of the present disclosure, the threshold voltage Vth of the first transistor T1 may not affect the driving current Id flowing through the light emitting element LD by the first to fourth periods t1, t2, t3, and t4. Referring to Equation 5, during the fourth period t4, the driving current Id flowing to the light emitting element LD may not be affected by the threshold voltage Vth of the first transistor T1. The light emitting element LD may be proportional to the square of the data signal Vdata regardless of characteristics of the first transistor T1. Accordingly, the luminance of the image IM (see FIG. 2) output from the display panel DP (see FIG. 3) may be maintained uniformly. Accordingly, the pixel PXij with the improved display quality and the electronic device 1000 (see FIG. 3) including the same may be provided.

Furthermore, a voltage level of the second power source ELVSS in the second power source line PL2 may be changed by a voltage drop (referred to as “IR drop”). However, according to an embodiment of the present disclosure, the second power source ELVSS may not affect the driving current Id flowing through the light emitting element LD by the first to fourth periods t1, t2, t3, and t4. Referring to Equation 5, during the fourth period t4, the driving current Id flowing to the light emitting element LD may not be affected by the second power source ELVSS. The light emitting element LD may be proportional to the square of the data signal Vdata regardless of the voltage level of the second power source ELVSS. Accordingly, the luminance of the image IM (see FIG. 2) output from the display panel DP (see FIG. 3) may be maintained uniformly. Accordingly, the pixel PXij with the improved display quality and the electronic device 1000 (see FIG. 2) including the same may be provided.

Moreover, according to an embodiment of the present disclosure, the first transistor T1 may be an N-type transistor, and the cathode CTD of the light emitting element LD may be electrically connected to a drain of the first transistor T1. In this case, even though the light emitting element LD deteriorates, a voltage of a source terminal of the first transistor T1, which affects the driving current Id, may not shift. That is, even when the light emitting element LD deteriorates, an upper gate-source voltage and a lower gate-source voltage of the first transistor T1 may not change. The upper gate-source voltage may be a voltage between the first gate electrode G1 and the source. The lower gate-source voltage may be a voltage between the second gate electrode G2 and the source. Accordingly, because the range of a change in the amount of current flowing through the first transistor T1 is not relatively great even when the usage time increases, the afterimage defect (or poor long-term afterimage) of the display panel DP (see FIG. 3) may be reduced and the lifespan of the display panel DP (see FIG. 3) may be improved. Accordingly, the pixel PXij with the improved display quality and the electronic device 1000 (see FIG. 3) including the same may be provided.

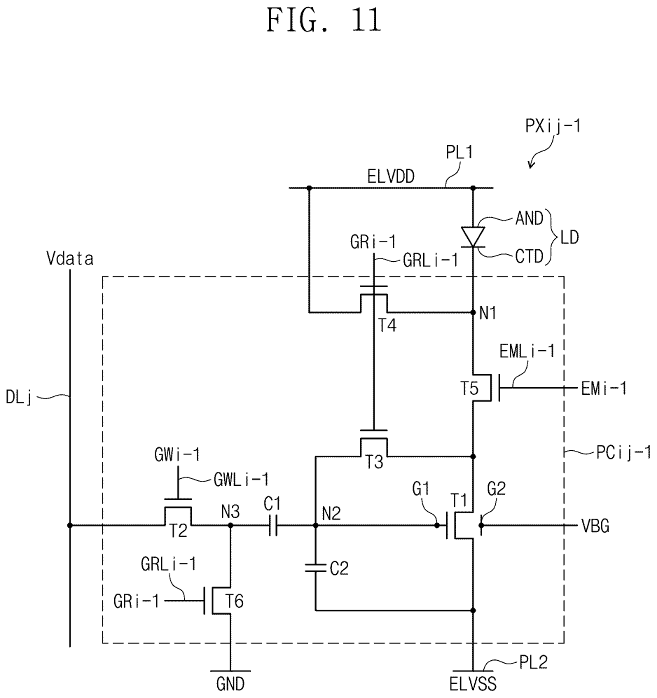

FIG. 11 is an equivalent circuit diagram of a pixel PXij-1, according to an embodiment of the present disclosure. In the description of FIG. 11, the same reference numerals are assigned to the same components described with reference to FIG. 4, and thus the descriptions thereof are omitted.

Referring to FIG. 11, the pixel PXij-1 may include the light emitting element LD and a pixel driving circuit PCij-1.

The pixel driving circuit PCij-1 may include first to sixth transistors T1, T2, T3, T4, T5, and T6 and capacitors C1 and C2.

The pixel PXij-1 according to an embodiment of the present disclosure may be referred to as having a 6T2C structure.

Each of the first to sixth transistors T1 to T6 may be an N-type transistor by using an oxide semiconductor as a semiconductor layer.

The first transistor T1 may include a first electrode electrically connected to the first node N1 via the fifth transistor T5, a second electrode connected to the second power source line PL2 to which the second power source ELVSS is provided, the first gate electrode G1 connected to the second node N2, and the second gate electrode G2 to which the lower gate voltage VBG is provided.

The second transistor T2 may include a first electrode electrically connected to the data line DLj to which the data signal Vdata is provided, a second electrode connected to the third node N3, and a gate electrode receiving a first scan signal GWi-1. The gate electrode may be connected to a first scan line GWLi-1. The second transistor T2 may be referred to as a “switch transistor”.

The third transistor T3 may include a first electrode connected to the second node N2, a second electrode connected to the first electrode of the first transistor T1, and a gate electrode receiving a second scan signal GRi-1. The gate electrode may be connected to a second scan line GRLi-1. The third transistor T3 may be referred to as a “compensation transistor”.

The fourth transistor T4 may include a first electrode connected to the first power source line PL1, a second electrode electrically connected to the first node N1, and a gate electrode receiving the second scan signal GRi-1. The gate electrode may be connected to the second scan line GRLi-1.

The fifth transistor T5 may include a first electrode connected to the first node N1, a second electrode connected to the first electrode of the first transistor T1, and a gate electrode receiving an emission signal EMi-1. The gate electrode may be connected to the emission control line EMLi-1.

The sixth transistor T6 may include a first electrode connected to the third node N3, a second electrode connected to the ground electrode GND provided with a ground voltage, and a gate electrode receiving the second scan signal GRi-1. The gate electrode may be connected to the second scan line GRLi-1.

The first capacitor C1 may be connected between the second node N2 and the third node N3. The first capacitor C1 may include a first electrode connected to the first gate electrode G1 of the first transistor T1 and a second electrode connected to the second transistor T2.

The second capacitor C2 may be connected between the second node N2 and the second power source line PL2. The second capacitor C2 may include a first electrode and a second electrode. The first electrode of the second capacitor C2 may be connected to the first gate electrode G1 of the first transistor T1.

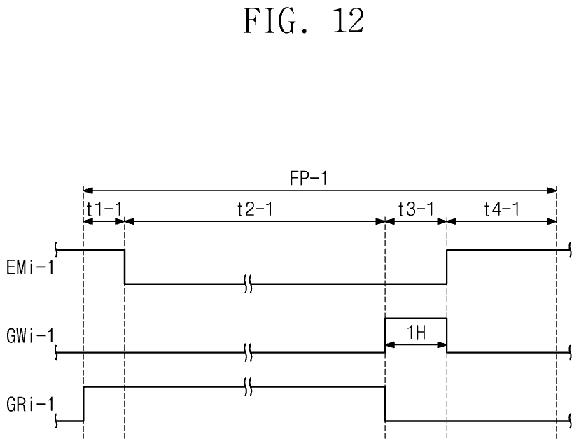

FIG. 12 is a timing diagram for describing an operation of an electronic device, according to an embodiment of the present disclosure. In the description of FIG. 12, the same reference numerals are assigned to the same components described with reference to FIG. 6, and thus the descriptions thereof are omitted to avoid redundancy.

Referring to FIG. 12, the display panel DP (see FIG. 3) may display the image IM (see FIG. 2) by operating in units of frame period FP-1. Any one frame period FP-1 may include first to fourth periods t1-1, t2-1, t3-1, and t4-1. The first to third periods t1-1, t2-1, and t3-1 may be referred to as “non-emission periods”, and the fourth period t4-1 may be referred to as an “emission period”.

In the first period t1-1, the emission signal EMi-1 and the second scan signal GRi-1 may be at active levels. The active levels of the emission signal EMi-1 and the second scan signal GRi-1 may be high levels.

The first scan signal GWi-1 may be at an inactive level. The inactive level of the first scan signal GWi-1 may be a low level.

The third transistor T3, the fourth transistor T4, and the sixth transistor T6 may be turned on in response to the second scan signal GRi-1.

The fifth transistor T5 may be turned on in response to the emission signal EMi-1.

The first power source ELVDD may be provided to the first node N1 and the second node N2. The ground voltage may be provided to the third node N3.

The first period t1-1 may be referred to as an “initialization period”.

In the second period t2-1, the second scan signal GRi-1 may be at an active level. The emission signal EMi-1 and the first scan signal GWi-1 may be at inactive levels.

The lower gate voltage VBG may be applied to the second gate electrode G2 of the first transistor T1. The voltage obtained by subtracting a source voltage from the voltage of the second gate electrode G2 may have a negative voltage level. For example, the voltage obtained by subtracting the second power source ELVSS from the lower gate voltage VBG may have a negative voltage level.

As the third transistor T3 is turned on, the first gate electrode G1 and the drain electrode of the first transistor T1 may be connected to each other. The first transistor T1 may operate in a diode-connected structure. For this reason, the threshold voltage of the first transistor T1 may be extracted.

The second period t2-1 may be referred to as a “threshold voltage extraction period” or a “compensation period”.

In the third period t3-1, the first scan signal GWi-1 may be at an active level. The emission signal EMi-1 and the second scan signal GRi-1 may be at inactive levels.

The second transistor T2 may be turned on in response to the first scan signal GWi-1. The data signal Vdata provided through the data line DLj may be provided to the third node N3.

The third period t3-1 may be referred to as a “write period”.

In the fourth period t4-1, the emission signal EMi-1 may be at an active level. The first scan signal GWi-1 and the second scan signal GRi-1 may be at inactive levels.

The fifth transistor T5 may be turned on in response to the emission signal EMi-1. A current path may be formed from the first power source line PL1 to the light emitting element LD, the fifth transistor T5, the first transistor T1, and the second power source line PL2. That is, a driving current may flow from the first power source line PL1 via the light emitting element LD, the fifth transistor T5, the first transistor T1, and the second power source line PL2.

The fourth period t4-1 may be referred to as an “emission period”.

Although an embodiment of the present disclosure has been described for illustrative purposes, those skilled in the art will appreciate that various modifications, and substitutions are possible, without departing from the scope and spirit of the present disclosure as disclosed in the accompanying claims. Accordingly, the technical scope of the present disclosure is not limited to the detailed description of this specification, but should be defined by the claims.

As described above, a first transistor may guarantee an enhancement mode because a voltage obtained by subtracting a voltage of a second electrode from a voltage of a second gate electrode has a negative voltage level. In the enhancement mode, the first transistor may be turned off when an upper gate-source voltage of the first transistor is equal to a threshold voltage of the first transistor. During a second period, the threshold voltage of the first transistor may be easily extracted without time constraints. It is possible to accurately extract and compensate for the threshold voltage. Accordingly, a pixel and an electronic device with improved reliability may be provided.

Moreover, as described above, a voltage corresponding to a data signal may be distributed by a first capacitor and a second capacitor. The data voltage range may be expanded by the distributed voltage of the data signal. For this reason, a current error of the first transistor may be reduced. Furthermore, the load on a data driving circuit may be reduced. Accordingly, a pixel and an electronic device with improved reliability may be provided.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A pixel comprising:
a light emitting element connected between a first power source line, through which a first power source is provided, and a first node;
a first transistor including a first electrode connected to the first node, a second electrode connected to a second power source line provided with a second power source having a lower voltage level than the first power source, a first gate electrode connected to a second node, and a second gate electrode provided with a gate voltage;
a first capacitor connected between the second node and a third node;
a second transistor connected between a data line, to which a data signal is provided, and the third node and including a gate electrode for receiving a first scan signal; and
a second capacitor connected between the second node and the second power source line,
wherein a voltage obtained by subtracting a voltage of the second electrode from a voltage of the second gate electrode has a negative voltage level.

2. The pixel of claim 1, wherein a semiconductor layer of each of the first transistor and the second transistor includes an oxide semiconductor.

3. The pixel of claim 1, further comprising:
a fourth transistor connected between the first node and the first power source line and including a gate electrode receiving a second scan signal.

4. The pixel of claim 3, further comprising:
a sixth transistor connected between the third node and a ground electrode and including a gate electrode receiving the second scan signal.

5. The pixel of claim 3, further comprising:
a third transistor connected between the second node and the first transistor and including a gate electrode.

6. The pixel of claim 5, wherein a third scan signal is provided to the gate electrode of the third transistor.

7. The pixel of claim 5, wherein the second scan signal is provided to the gate electrode of the third transistor.

8. The pixel of claim 6, further comprising:
a fifth transistor connected between the first node and the first transistor and including a gate electrode receiving an emission signal.

9. The pixel of claim 8, further comprising:
a seventh transistor connected between the first node and the second node and including a gate electrode receiving a scan signal obtained by shifting the first scan signal by a predetermined time.

10. The pixel of claim 9, wherein during a first period, the scan signal and the second scan signal are at active levels.

11. The pixel of claim 10, wherein during the first period, the first power source is provided to the first node and the second node.

12. The pixel of claim 10, wherein during a second period continuous with the first period, the second scan signal and the third scan signal are at active levels.

13. The pixel of claim 12, wherein during the second period, a voltage value obtained by adding a threshold voltage of the first transistor to the second power source is provided to the second node.

14. The pixel of claim 12, wherein during a third period continuous with the second period, the first scan signal is at an active level.

15. The pixel of claim 14, wherein during the third period, the data signal is provided to the third node, and a length of the third period is smaller than a length of the second period.

16. The pixel of claim 14, wherein during a fourth period continuous with the third period, the emission signal is at an active level.

17. An electronic device comprising:
a display panel including a plurality of pixels,
wherein each of the plurality of pixels includes:
a light emitting element connected between a first power source line, through which a first power source is provided, and a first node;
a first transistor connected between the first node and a second power source line provided with a second power source having a lower voltage level than the first power source and including a first gate electrode connected to a second node and a second gate electrode provided with a gate voltage;
a first capacitor connected between the second node and a third node;
a second transistor connected between a data line, to which a data signal is provided, and the third node and including a gate electrode for receiving a first scan signal;
a second capacitor connected between the second node and the second power source line;
a fourth transistor connected between the first node and the first power source line and including a gate electrode receiving a second scan signal; and
a third transistor connected between the second node and the first transistor and including a gate electrode receiving a third scan signal,
wherein a voltage obtained by subtracting the second power source from the gate voltage has a negative voltage level.

18. The electronic device of claim 17, wherein a semiconductor layer of each of the first transistor and the second transistor includes an oxide semiconductor.

19. The electronic device of claim 17, wherein during a second period, the second scan signal and the third scan signal are at active levels, and a voltage value obtained by adding a threshold voltage of the first transistor to the second power source is provided to the second node.

20. The electronic device of claim 19, wherein during a third period continuous with the second period, the first scan signal is at an active level, the data signal is provided to the third node, and a length of the third period is smaller than a length of the second period.
